(19) United States
(12) Patent Application Publication
(10) Pub. No.: US 2016/0300395 A1
(43) Pub. Date: Oct. 13, 2016

(54) Redirected Movement in a Combined Virtual and Physical Environment

(71) Applicant: The Void, LLC, Lindon, UT (US)

(72) Inventors: Ken Bretschneider, Pleasant Grove, CA (US); Curtis Hickman, Pleasant Grove, UT (US); James Jenson, North American, UT (US)

(73) Assignee: The Void, LLC, Lindon, UT (US)

(21) Appl. No.: 15/183,839

(22) Filed: Jun. 16, 2016

Related U.S. Application Data
(63) Continuation-in-part of application No. 14/942,878, filed on Nov. 16, 2015.
(60) Provisional application No. 62/080,308, filed on Nov. 15, 2014.
(60) Provisional application No. 62/080,307, filed on Nov. 15, 2014.

(51) Int. Cl. G06T 19/00; G06T 7/60; G06T 7/00; G06F 3/01; G06T 7/20

(52) U.S. Cl. CPC G06T 19/006; G06F 3/011; G06T 7/20; G06T 7/004; G06T 7/60

(57) ABSTRACT

A combined physical and virtual environment in which a user's position in a physical environment is displayed in an offset position within the virtual environment. The offset is determined based on mapping between the physical environment and the virtual environment and offsets generated for a user position and direction as a user moves throughout the physical environment. The physical environment and corresponding virtual environment may have a different layout. The offsets are used to correlate portions of the physical environment and virtual environments together so that a user does not realize the differences between the environments. By providing offsets in this manner, an enclosed physical environment may be used to provide an expanded and unlimited virtual environment for user to navigate and explore.

### CROSS-REFERENCE TO RELATED APPLICATIONS

This application is a continuation in part and claims the priority benefit of U.S. patent application Ser. No. 14/942,878, titled “Combined Virtual and Physical Environment,” filed Nov. 15, 2015, which claims the priority benefit of U.S. provisional application 62/080,308, titled “Systems and Methods for Creating Combined Virtual and Physical Environments,” filed Nov. 15, 2014, and U.S. provisional application 62/080,307, titled “Systems and Methods for Creating Combined Virtual and Physical Environments,” filed Nov. 15, 2014, the disclosures of which are incorporated herein by reference.

### BACKGROUND OF THE INVENTION

Virtual reality technology is becoming more sophisticated and available to the general public. Currently, many virtual reality systems require a user to sit in a chair, wear a bulky headset, and face a specific direction while limited optical sensors track certain movements of portions of the headset. As a user moves his head from side to side, an image provided to a user may change. The optical sensors provide a line-of-sight signal to a headset and may provide input to a remote server to update a graphical interface when the headset is detected to shift to the left or the right.

Virtual reality systems based on optical tracking have significant limitations. First, virtual-reality tracking systems based on optical sensors require a line of sight between the optical sensor and the user. Additionally, the virtual reality environments are limited to a space defined by a physical arena or space. What is needed is an improved virtual-reality system.

### SUMMARY OF THE CLAIMED INVENTION

The present technology, roughly described, provides a combined physical and virtual environment in which a user's position in a physical environment is displayed in an offset position within the virtual environment. The offset is determined based on mapping between the physical environment and the virtual environment and offsets generated for a user position and direction as a user moves throughout the physical environment. The physical environment and corresponding virtual environment may have a different layout. The offsets are used to correlate portions of the physical environment and virtual environments together so that a user does not realize the differences between the environments. By providing offsets in this manner, an enclosed physical environment may be used to provide an expanded and unlimited virtual environment for user to navigate and explore.

In some implementations, when a user moves through a physical environment that is curved or otherwise nonlinear, offsets may be used to make it appear that a user is traveling in a straight direction in a corresponding virtual environment. In fact, if the physical environment includes a closed loop curve (e.g., a circular hallway), a user may be guided indefinitely along a straight path or “infinite hallway.”

In an embodiment, a method may provide a combined virtual and physical environment. A local machine may track a user position in a physical environment. The local machine may also determine the user's position in a virtual environment based on the user's tracked position in the physical environment and offset data.

In an embodiment, a system for transmitting a plurality of wide band tracking signals within a position tracking system may include a processor, memory, and one or more modules stored in memory. The one or more modules may be executable by the processor to track a user position in a physical environment and display the user's position in a virtual environment based on the user's tracked position in the physical environment and offset data.

### BRIEF DESCRIPTION OF THE DRAWINGS

FIG. 1 is a block diagram of a virtual reality system for correlating movement in a first layout of a physical environment with an offset displayed movement in a virtual environment.

FIG. 2A is a top view of an exemplary physical environment for use with a combined physical and virtual environment.

FIG. 2B is a top view of the exemplary physical environment with a representation of an offset virtual environment display provided to a user.

FIG. 3A illustrates an exemplary navigational path within the exemplary physical environment.

FIG. 3B illustrates an exemplary navigational path within a virtual environment that corresponds to the exemplary navigational path within the exemplary physical environment.

FIG. 4 illustrates a method for providing a combined physical and virtual environment.

FIG. 5 illustrates a method for mapping a physical space to a virtual environment.

FIG. 6 illustrates a method for determining offsets for a user within a virtual environment.

FIG. 7 illustrates a model for calculating a positional offset for a user within a virtual environment.

FIG. 8 illustrates another model for calculating a positional offset for a user within a virtual environment.

FIG. 9 illustrates a method for generating secondary objects to represent users in a virtual environment.

FIG. 10 illustrates a method for configuring speed of a user through a portion of a virtual environment.

FIG. 11 is a block diagram of a computing device for use with the present technology.

### DETAILED DESCRIPTION

The present technology, roughly described, provides a combined physical and virtual environment in which a user's position in a physical environment is displayed in an offset position within the virtual environment. The offset is determined based on mapping between the physical environment and the virtual environment and offsets generated for a user position and direction as a user moves throughout the physical environment. The physical environment and corresponding virtual environment may have a different layout. The offsets are used to correlate portions of the physical environment and virtual environments together so that a user does not realize the differences between the environments. By providing offsets in this manner, an enclosed physical environment may be used to provide an expanded and unlimited virtual environment for user to navigate and explore.

In some implementations, when a user moves through a physical environment that is curved or otherwise nonlinear, offsets may be used to make it appear that a user is traveling in a straight direction in a corresponding virtual environment. In fact, if the physical environment includes a closed loop curve (e.g., a circular hallway), a user may be guided indefinitely along a straight path or “infinite hallway.”

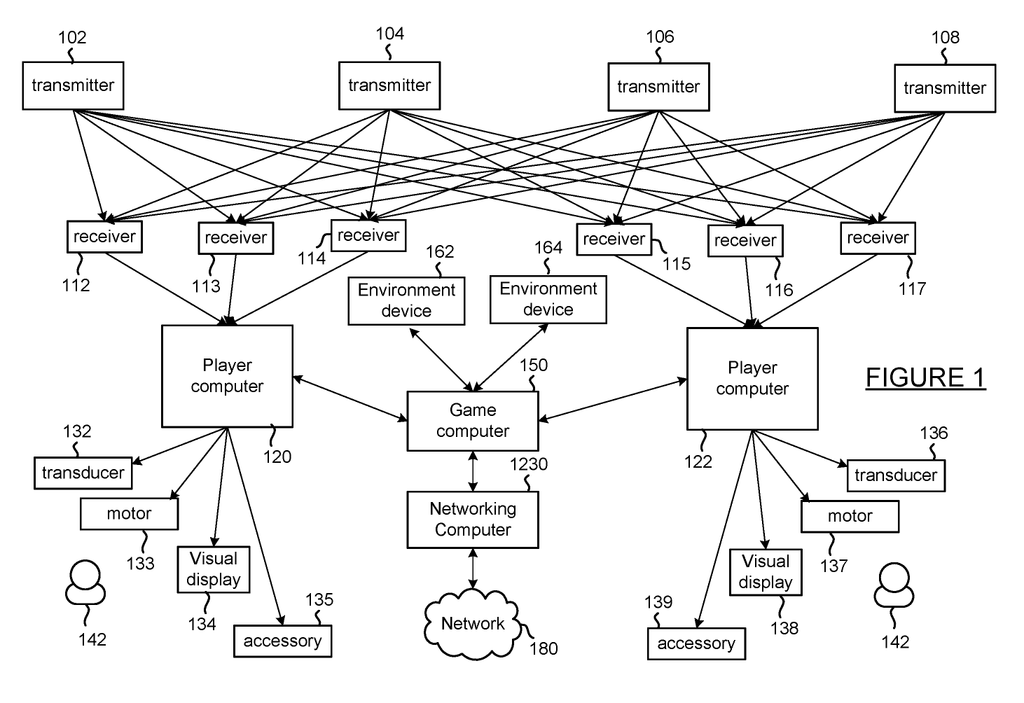

FIG. 1 is a block diagram of a virtual reality system for correlating movement in a first layout of a physical environment with an offset displayed movement in a virtual environment. The system of FIG. 1 includes transmitters 102, 104, 106, and 108, receivers 112, 113, 114, 115, 116 and 117, player computers 120 and 122, transducers 132 and 136, motors 133 and 137, virtual display 134 and 138, accessories 135 and 139, players 140 and 142, game computer 150, environment devices 162 and 164, networking computer 170, and network 180.

Receivers 112-117 may be placed on a player 140 or an accessory 135. Each receiver may receive one or more signals from one or more of transmitters 102-108. The signals received from each transmitter may include an identifier to identify the particular transmitter. In some instances, each transmitter may transmit an omnidirectional signal periodically at the same point in time. Each receiver may receive signals from multiple transmitters, and each receiver may then provide signal identification information and timestamp information for each received signal to player computer 120. By determining when each transmitter signal is received from a receiver, player computer 120 may identify the location of each receiver.

Player computer 120 may be positioned on a player, such as for example on the back of a vest worn by a player. A player computer may receive information from a plurality of receivers, determine the location of each receiver, and then locally update a virtual environment accordingly. Updates to the virtual environment may include a player's point of view in the environment, events that occur in the environment, and video and audio output to provide to a player representing the player's point of view in the environment along with the events that occur in the environment.

Player computer 120 may also communicate changes to the virtual environment determined locally at the computer to other player computers, such as player computer 122, through game computer 150. In particular, a player computer for a first player may detect a change in the player's position based on receivers on the player's body, determine changes to the virtual environment for that player, provide those changes to game computer 150, and game computer 150 will provide those updates to any other player computers for other players in the same virtual reality session, such as a player associated player computer 122.

A player 140 may have multiple receivers on his or her body. The receivers receive information from the transmitters 102-108 and provide that information to the player computer. In some instances, each receiver may provide the data to the player computer wirelessly, such as for example through a radiofrequency signal such as a Bluetooth signal. In some instances, each receive may be paired or otherwise configured to only communicate data with a particular players computer. In some instances, a particular player computer may be configured to only receive data from a particular set of receivers. Based on physical environment events such as a player walking, local virtual events that are provided by the players computer, or remote virtual events triggered by an element of the virtual environment located remotely from the player, haptic feedback may be triggered and sensed by a player. The haptic feedback may be provided in the terms of transducer 132 and motor 133. For example, if an animal or object touches a player at a particular location on the player's body within the virtual environment, a transducer located at that position may be activated to provide a haptic sensation of being touched by that object.

Visual display 134 may be provided through a headset worn by player 140. The virtual display 134 may include a helmet, virtual display, and other elements and components needed to provide a visual and audio output to player 140. In some instances, player computer 120 may generate and provide virtual environment graphics to a player through the virtual display 140.

Accessory 135 may be an element separate from the player, in communication with player computer 120, and displayed within the virtual environment through visual display 134. For example, an accessory may include a gun, a torch, a light saber, a wand, or any other object that can be graphically displayed within the virtual environment and physically engaged or interacted with by player 140. Accessories 135 may be held by a player 140, touched by a player 140, or otherwise engaged in a physical environment and represented within the virtual environment by player computer 120 through visual display 134.

Game computer 150 may communicate with player computers 120 and 122 to receive updated virtual information from the player computers and provide that information to other player computers currently active in the virtual reality session. Game computer 150 may store and execute a virtual reality engine, such as Unity game engine, Leap Motion, Unreal game engine, or another virtual reality engine. Game computer 150 may also provide virtual environment data to networking computer 170 and ultimately to other remote locations through network 180.

Environment devices 162 may include physical devices that form part of the physical environment. The devices 162 may provide an output that may be sensed or detected by a player 140. For example, an environment device 162 may be a source of heat, cold, wind, sound, smell, vibration, or some other sense that may be detected by a player 140.

Transmitters 102-108 may transmit a synchronized wideband signal within a pod to one or more receivers 112-117. Logic on the receiver and on a player computing device, such as player computing device 120 or 122, may enable the location of each receiver to be determined in a universal space within the pod.

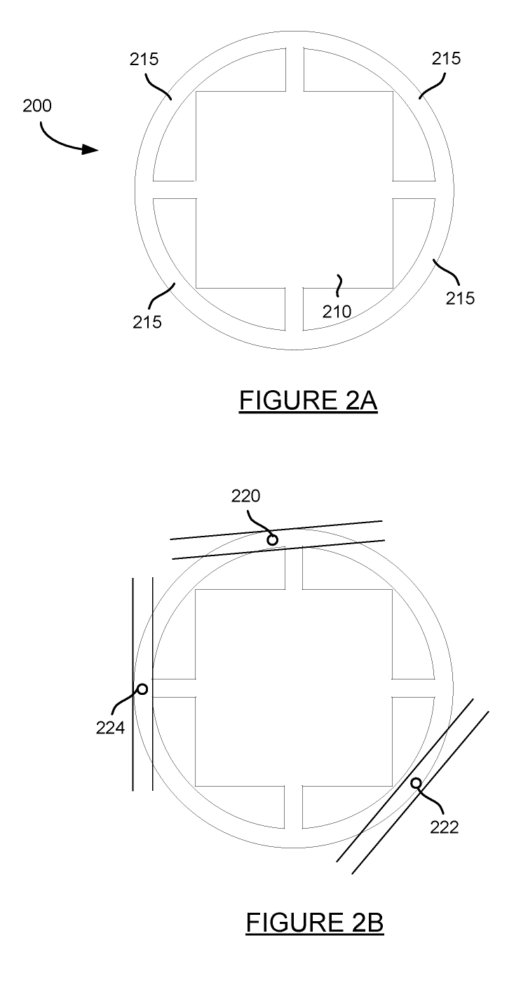

FIG. 2A is a top view of an exemplary physical environment for use with a combined physical and virtual environment. The physical environment of FIG. 2A includes a square space 210 and a curved space 215. The curved space 215 forms a circle around square space 210, with four passage ways connecting the curved space and square space. When movement of a user is detected to travel along the curved physical environment, a graphics engine that provides the virtual environment, such as for example a UNITY graphical engine, may present the navigation as a straight path in the virtual environment. Hence, the offset navigation path within the virtual environment makes the curved travel path within the physical environment appear as a straight travel path in a corresponding virtual environment.

FIG. 2B is a top view of the exemplary physical environment with a representation of an offset virtual environment display provided to a user. As shown in FIG. 2B, for each point within the curved layout, a user's view within the virtual environment can appear to be straight. For example, at curved point 220, 222 and 224, the virtual environment may be offset to make it appear to the user that the user is traveling in a straight line. In some embodiments, the straight line within the virtual environment may be tangent to the point in the curve of the physical environment.

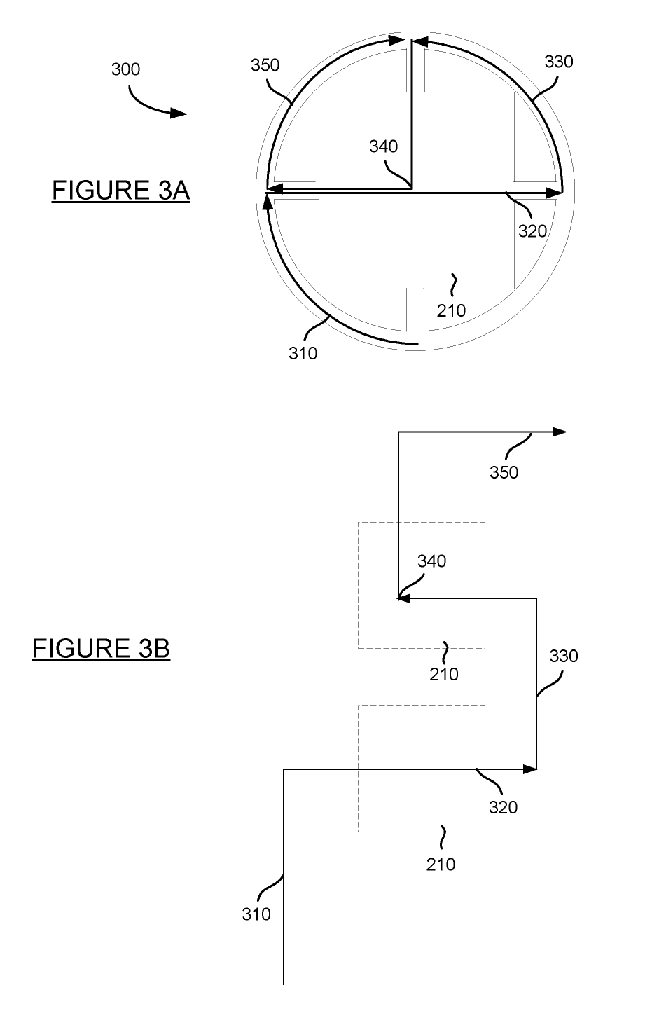

FIG. 3A illustrates an exemplary navigational path within the exemplary physical environment. The exemplary navigational path includes a curved section 310, followed by a right turn to continue straight on path 320, followed by a left turn to continue on a curved path 330, followed by a left turn to continue on path 340, followed by a right turn to continue on curved path 350. In the physical environment, without any virtual reality system, the path illustrated in FIG. 3A would have a user move through space 210 twice and includes several curved portions.

FIG. 3B illustrates an exemplary navigational path within a virtual environment that corresponds to the exemplary navigational path within the exemplary physical environment. As shown in FIG. 3B, the navigational path within the virtual environment does not include any curved portions. The curved portions have been processed with offsets within the virtual environment to make them appear to a user as straight paths. In particular, the navigational path within the virtual environment includes straight portion 310, straight portion 320 to the right of portion 310, a left turn to straight portion 330, another left turn along a portion 340, and a right turn along a portion 350. A graphical engine may track a user's movement and present space 210 as different spaces within the virtual environment. As such, a physical environment with nonlinear portions may be used to provide an extended and unlimited virtual environment that reuses a particular physical space as different virtual spaces.

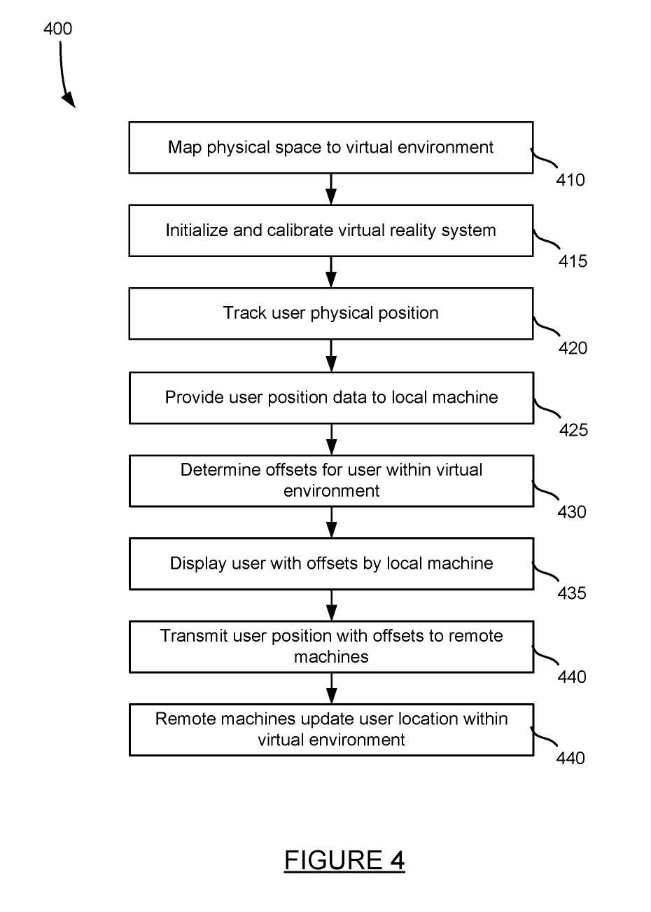

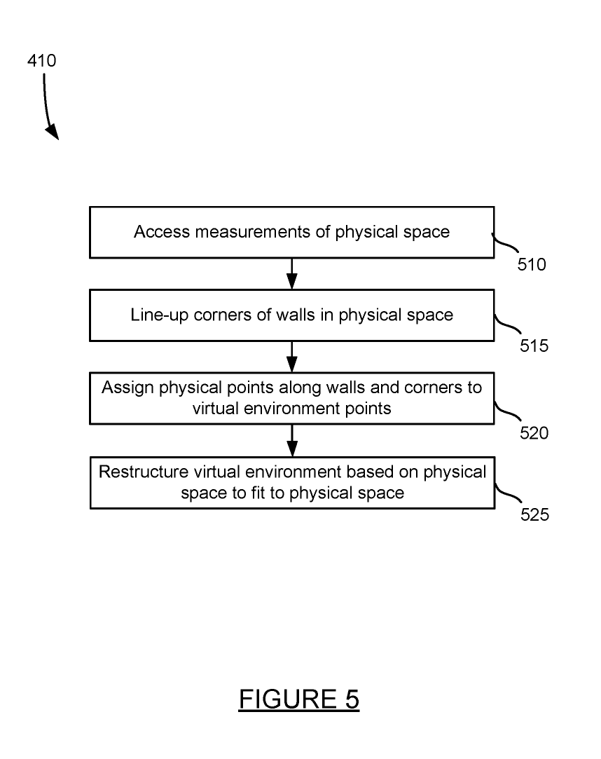

FIG. 4 illustrates a method for providing a combined physical and virtual environment. Physical space is mapped to a virtual environment at step 410. Points in the physical space may be measured and correlated to corresponding points in the virtual environment. Points may include corners, walls, and other points or positions. Mapping a physical space to a virtual environment is discussed in more detail with respect to the method of FIG. 5.

A virtual reality system may be initialized and calibrated at step 415. Initialization and calibration may include calibrating a tracking system, initializing the virtual environment software, and other initialization and calibration tasks.

The user's physical position may be tracked at step 420. A user may be tracked continuously as the user navigates throughout the physical environment. As the user moves throughout the physical environment, position data generated by a tracking system is provided to a local machine at step 425. The local machine may be, in some implementations, attached, coupled, worn, or otherwise positioned on a user's body. The user position data may include data indicating a position of one or more receivers located on portions of the user, objects carried by the user, or at other locations.

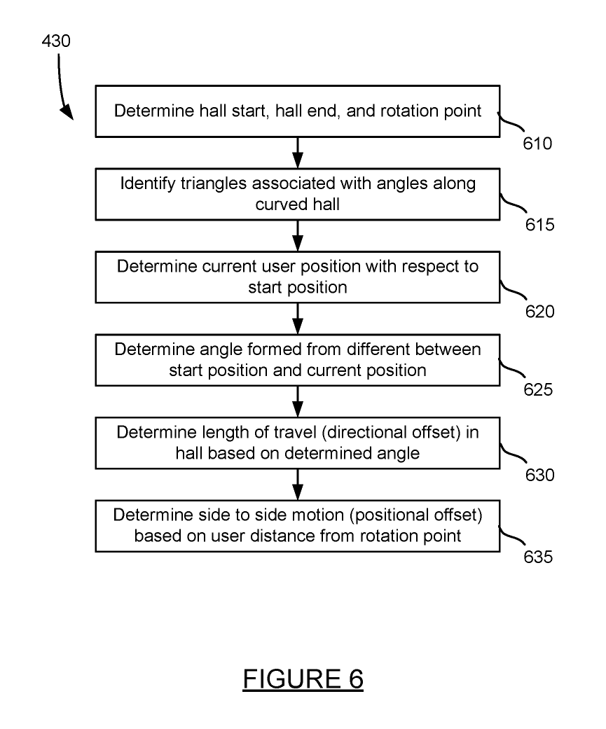

Offsets for the user within the virtual environment may be determined at step 430. The offsets may include directional offsets, positional offsets, and may be used to alter a perceived path of the user within a virtual environment from an actual path of the user within a physical environment. For example, the offsets may be used to make a physical curved path traveled by a user appear as a straight path within the virtual environment. Determining offsets for user within a virtual environment is discussed in more detail with respect to the method of FIG. 6.

A user is displayed within a virtual environment with offsets at step 435. A user may be displayed as a first object within the virtual environment. The movement of the user within the virtual environment may be displayed based on tracking data received by the local machine and offsets determined based on the location of the user. An offset user position is transmitted to remote machines at step 440. In some instances, the local machine of the user may first transmit the user's offset location to a game computer, and the game computer may transmit the offset user position data to other user computers or remote machines. The remote machines may update the user location within the virtual environment for the particular user associated with a remote machine at step 440. Hence, as a user moves around a physical environment, the updated offset position of the user within the virtual environment is provided to other users participating in a virtual reality session in real time.

FIG. 5 illustrates a method for mapping a physical space to a virtual environment. The method of FIG. 5 provides more detail for step 410 of the method of FIG. 4. Measurements of a physical space are accessed at step 510. Measurements may be accessed from memory, data received by an administrator, or some other location. Corners of walls within the physical space are lined up at step 515. Lining up wall corners may ensure that the measurements of the physical space resulted in aligned rooms, walls, and other spaces.

Physical points along the walls and corners are assigned to points within a virtual environment at step 520. Assigning the physical points to the virtual environment points ensures that the physical walls are aligned with walls displayed within the virtual environment and can be interacted with as such. Virtual environment may be restructured based on the physical space to fit the physical space at step 525. Restructuring a virtual environment may include adjusting the size of virtual spaces, adjusting a speed at which a user may travel through a particular space and adjusting other parameters of the virtual environment.

FIG. 6 illustrates a method for determining offsets for a user within a virtual environment. The method of FIG. 6 provides more detail of step 430 the method of FIG. 4. First, points within a physical environment are determined at step 610. Points may include a hall start, hall end, and rotation point. The hall start may be a point within the physical space at which a nonlinear hall or other traversable space begins. The hall end may be a point at which a nonlinear or other traversable space ends. The rotation point may be selected as a point at which the user may be determined to rotate about as the user traverses the nonlinear hall. The rotation point may be calculated as am imaginary rotation center at the 90 degree angle point on an isosceles right triangle with the hypotenuse extending between the curved hallway end and the straight hallway end.

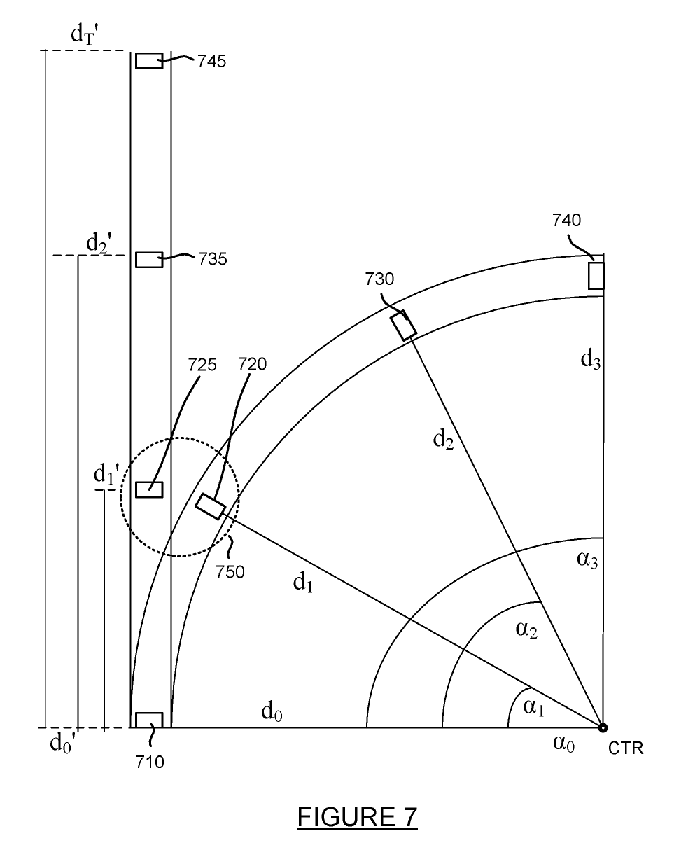

FIG. 7 illustrates a model for calculating a positional offset for a user within a virtual environment. In the model of FIG. 7, the hall start may be positioned at the location 710 and the hall end may be positioned at location 740. The rotation point in the model of FIG. 7 may be the point at which the hall start and hall end form a right angle (labeled point “CTR).

Returning to FIG. 6, triangles associated with angles along a curved hallway are identified at step 615. In the model of FIG. 7, as a user traverses along the curved path, the distance traveled along the curve may be associated with an angle. The angle may be associated with a particular predetermined triangle. Each identified triangle may be associated with a particular distance of travel along the curved path and may be used to generate a different offset. In FIG. 7, the preset triangles may be associated with angles α1, α2, and α3, though different numbers of angles may be used. Put another way, a set of distances along the curved travel path in the model of FIG. 7 may be identified at step 615.

A current user position with respect to a starting position is determined at step 620. The user position with respect to the star position is used to determine how far the user has traveled along the curved path in the model of FIG. 7. For example, a user may travel a distance associated with position 720, position 730, or position 740 with respect to original position 710 along the curved path in the physical environment. The angle formed from the difference between the start position and the user's current position is determined at step 625. In FIG. 7, the angle that would be associated with position 720 is α1, the angle that would be associated with position 730 is α2, and the angle that would be associated with position 740 is α3.

The length of travel in a virtual environment hall or path is determined based on the determined angle at step 630. The length of travel may be determined by applying the proportion of the angle traveled with respect to the maximum allowed angle of travel to the maximum length of travel in the corresponding path in the virtual environment. The proportion may be expressed as:

$$\frac{{∝}_{n}}{{∝}_{tot}} = \frac{{D}_{{n}^{′}}}{{D}_{{tot}^{′}}} ,$$

where the angle of travel is αn, the maximum possible angle of travel is αtot, the maximum possible distance traveled in the virtual environment is Dtot′, and the determined distance traveled in the virtual environment is Dn′.

Referring to FIG. 7, for an angle α1 associated with position 720, the corresponding portion along the virtual environment path would be 725. For an angle α2 associated with position 730, the corresponding position in the virtual environment path would be position 735.

A side to side position within a hall or other traversable space within the virtual environment is determined based on a distance the user is from the rotation point in the physical environment at step 635.

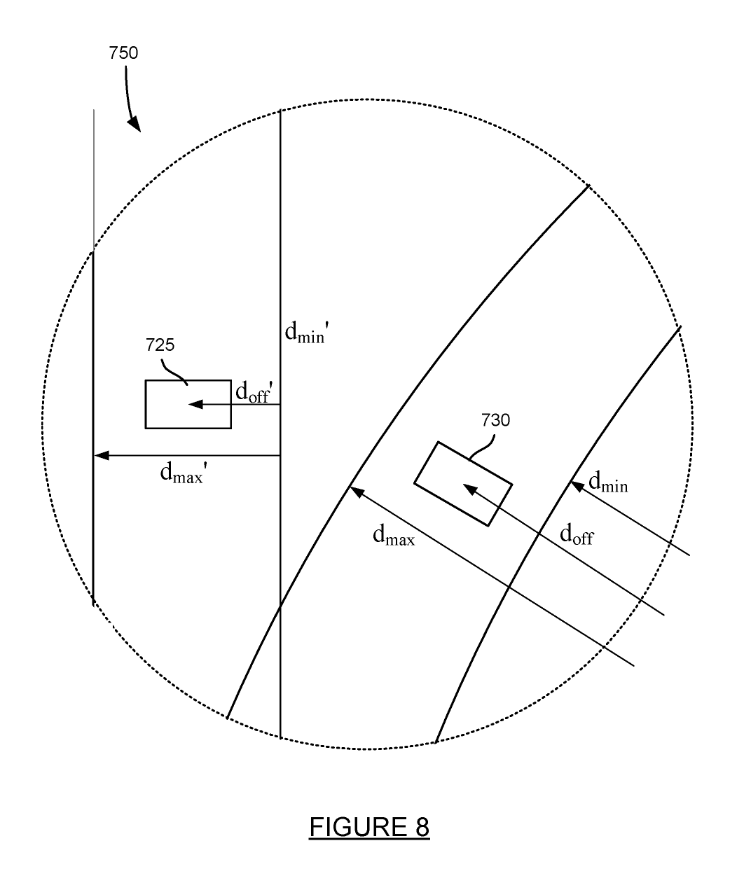

FIG. 8 illustrates another model for calculating a positional offset for a user within a virtual environment. The model of FIG. 8 illustrates a more detailed view of portion 750 of the model of FIG. 7. As shown in FIG. 8, a position within a physical environment path may be measured from the point of view of a rotation point.

A shortest distance a user may be to the rotation point may be represented by minimum distance dₘᵢₙ and the furthest distance a user may be to the rotation point may be represented by maximum distance dₘₐₓ. The actual distance a user is located from the rotation point may be represented as d_{off}. In the virtual environment, these distances are correlated to distances dₘᵢₙ′, dₘₐₓ′, and d_{off}′ in the straight path of the virtual environment.

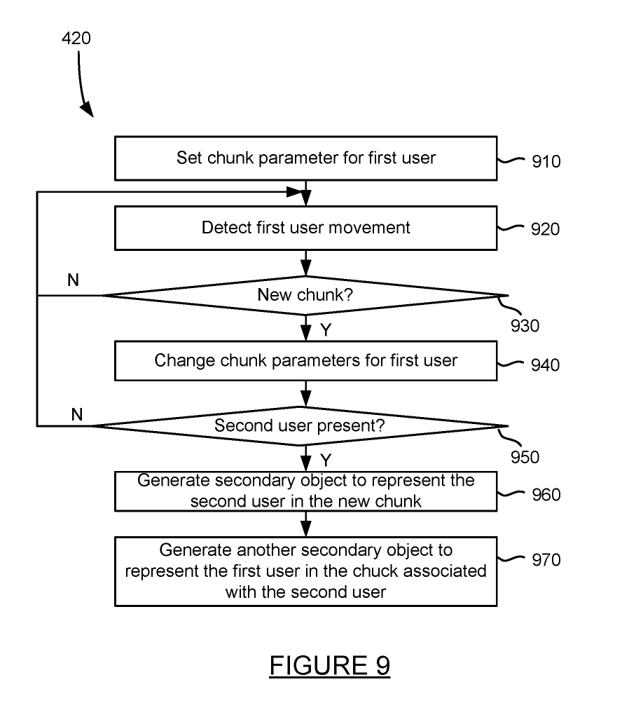

FIG. 9 illustrates a method for generating secondary objects to represent users in a virtual environment. First, a chunk parameter is set for a first user at step 910. Content provided within a virtual environment may be divided into chunks. Each chunk may include content for a portion of a virtual environment associated with a physical environment. For example, a chunk may include the virtual environment content associated with space 210 in the physical environment of FIG. 2A. As a user traverses the physical environment and enters space 210 multiple times, each entry into space 210 may be associated with a different “chunk” of content. In particular, in FIG. 3B, the first time a user enters space 210 along path 320, the user may experience virtual content associated with a first chunk while the second entry into space 210 along path 340 may be part of a separate chunk. In some implementations, associating a chunk parameter for a first user includes identifying the current chunk (i.e., the current virtual environment content) for the user. When a user passes certain points in a physical environment, such as new hallways, rooms, or other traversable spaces, the current chunk for the particular user may change.

A first user movement is detected at step 920. A determination is then made as to whether the first user movement results in a new chunk at step 930. If the movement does not result in a new chunk, the method of FIG. 9 returns to step 920. If the movement does result in a new chunk, the chunk parameters may be changed for the first user, for example to identify the new chunk the user will experience in the virtual environment.

A determination is made as to whether a second user is present in the physical space associated with the second chunk at step 1050. When a user moves from a first chunk to a second chunk, other users may exist in the same physical space as the first user but be experiencing different chunks of the virtual environment. If there are no other users in the present physical space in a chunk other than that of the first user, the method of FIG. 9 returns to step 920. If a second user is present in the physical space of the first user and is experiencing a different chunk than the first user, the method of FIG. 9 continues to step 960.

A secondary objects is generated to represent the second user in the new chunk for the first user at step 960. Though each user within the virtual environment is associated with a graphical object, a secondary graphical object may be generated to represent a particular user in a chunk other than that experienced by that particular user. This allows a user in a different chunk and the same physical space as the user to identify that another user, or some object, is in a physical space as the user in a different chunk, which helps to prevent collisions or other contact between the two users in the same physical space but different chunks. A secondary object may also be generated to represent the first user in the chunk associated with the second user at step 970.

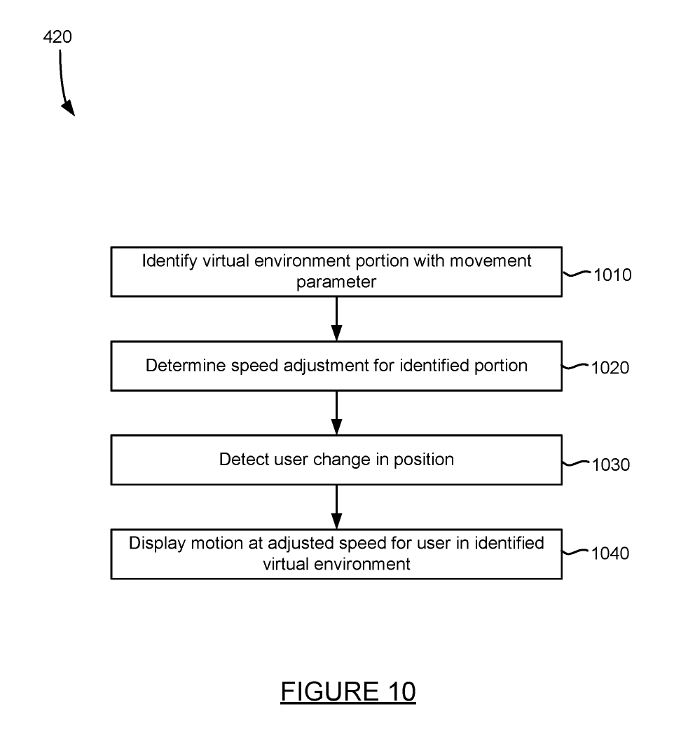

FIG. 10 illustrates a method for configuring a speed of a user through a portion of a virtual environment. A virtual environment portion with a movement parameter is identified at step 1010. Virtual environment portion may include an aspect that affects the user's movement, such as water, a cloud or air, an escalator, or other aspect. A speed adjustment is determined within the portion at step 1020. The speed adjustment may make the user. To move faster, slower, or different with respect to normal in some other way. A change in the user's position is detected at step 1030, and the user's motion is displayed at the adjusted speed in the identified virtual environment at step 1040. As such, the user may appear to move twice as fast, half as fast, rise or fall in a vertical direction, or have movement adjusted in some other way.

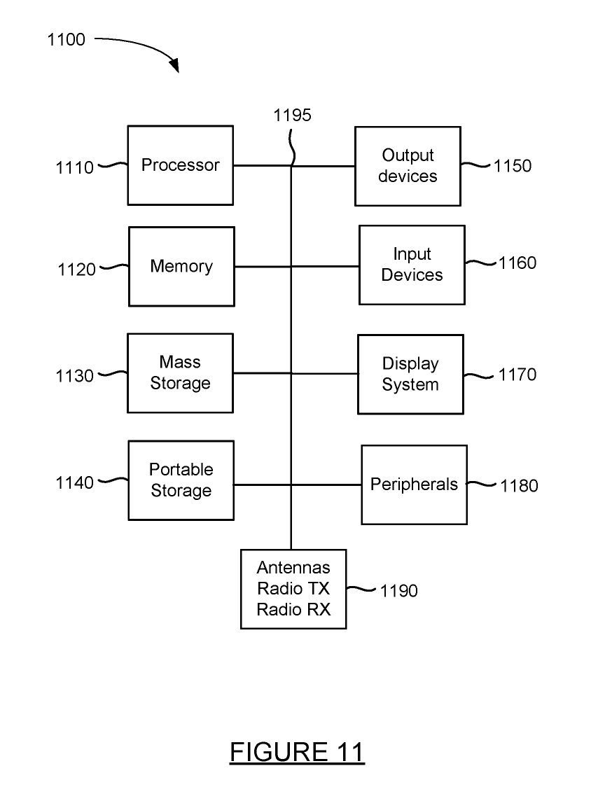

FIG. 11 illustrates an exemplary computing system 1100 that may be used to implement a computing device for use with the present technology. System 1100 of FIG. 11 may be implemented in the contexts of the likes of player computing devices 120 and 122 and game computer 150. The computing system 1100 of FIG. 11 includes one or more processors 1110 and memory 1110. Main memory 1110 stores, in part, instructions and data for execution by processor 1110. Main memory 1110 can store the executable code when in operation. The system 1100 of FIG. 11 further includes a mass storage device 1130, portable storage medium drive(s) 1140, output devices 1150, user input devices 1160, a graphics display 1170, and peripheral devices 1180.

The components shown in FIG. 11 are depicted as being connected via a single bus 1190. However, the components may be connected through one or more data transport means. For example, processor unit 1110 and main memory 1110 may be connected via a local microprocessor bus, and the mass storage device 1130, peripheral device(s) 1180, portable storage device 1140, and display system 1170 may be connected via one or more input/output (I/O) buses.

Mass storage device 1130, which may be implemented with a magnetic disk drive, an optical disk drive, or solid state non-volatile storage, is a non-volatile storage device for storing data and instructions for use by processor unit 1110. Mass storage device 1130 can store the system software for implementing embodiments of the present invention for purposes of loading that software into main memory 1110.

Portable storage device 1140 operates in conjunction with a portable non-volatile storage medium, such as a floppy disk, compact disk or Digital video disc, to input and output data and code to and from the computer system 1100 of FIG. 11. The system software for implementing embodiments of the present invention may be stored on such a portable medium and input to the computer system 1100 via the portable storage device 1140.

Input devices 1160 provide a portion of a user interface. Input devices 1160 may include an alpha-numeric keypad, such as a keyboard, for inputting alpha-numeric and other information, or a pointing device, such as a mouse, a trackball, stylus, or cursor direction keys. Additionally, the system 1100 as shown in FIG. 11 includes output devices 1150. Examples of suitable output devices include speakers, printers, network interfaces, and monitors.

Display system 1170 may include a liquid crystal display (LCD) or other suitable display device. Display system 1170 receives textual and graphical information, and processes the information for output to the display device.

Peripherals 1180 may include any type of computer support device to add additional functionality to the computer system. For example, peripheral device(s) 1180 may include a modem or a router.

The components contained in the computer system 1100 of FIG. 11 are those typically found in computer systems that may be suitable for use with embodiments of the present invention and are intended to represent a broad category of such computer components that are well known in the art. Thus, the computer system 1100 of FIG. 11 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Android, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for providing a combined virtual and physical environment, comprising:
tracking, by a local machine, a user position in a physical environment; and
displaying, by the local machine, the user's position in a virtual environment based on the user's tracked position in the physical environment and offset data.

2. The method of claim 1, wherein the physical environment includes a first layout through which the user may navigate, the virtual environment having a second layout through the user may navigate, the first layout and the second layout each having a differently shaped navigable path.

3. The method of claim 2, wherein the offset is generated based on a user position within the physical environment, the offset positioning the user within the second layout.

4. The method of claim 1, wherein the offset data includes a positional offset and a directional offset.

5. The method of claim 1, wherein a portion of the first layout is non-linear, the offset determined from a user position in the non-linear portion.

6. The method of claim 1, wherein the offset converts nonlinear movement within the physical environment to linear movement within the virtual environment.

7. The method of claim 1, further comprising:
determining user movement through a first percentage of a non-linear portion of the physical environment; and
positioning the user at a position associated with the first percentage of a length of a non-linear portion of the virtual environment.

8. The method of claim 1, further comprising:
continually detecting movement by a user in a non-linear portion of the physical environment, the non-linear portion including a curved portion; and
continually offsetting the user's perspective within the virtual environment to display a linear navigational path of the user.

9. The method of claim 1, wherein measured positions within the physical space are correlated with positions within the virtual environment.

10. The method of claim 1, wherein a first user and a second user are in a same portion of the physical environment and different portions of a virtual environment, the first user and second user associated with a graphical object in the virtual environment, further comprising generating a second object to represent the first user in the portion of the virtual environment including the second user.

11. The method of claim 1, wherein a portion of the virtual environment is configured to display movement of a user at a speed other than actual speed.

12. A non-transitory computer readable storage medium having embodied thereon a program, the program being executable by a processor to perform a method for providing a combined virtual and physical environment, the method comprising:
tracking, by a local machine, a user position in a physical environment; and
displaying, by the local machine, the user's position in a virtual environment based on the user's tracked position in the physical environment and offset data.

13. A system for providing a combined virtual and physical environment, comprising:
a processor;
memory; and
one or more modules stored in memory and executable by the processor to track a user position in a physical environment and display the user's position in a virtual environment based on the user's tracked position in the physical environment and offset data.
